(19) United States
(12) Patent Application Publication
(10) Pub. No.: US 2012/0097756 A1
(43) Pub. Date: Apr. 26, 2012

(54) SYSTEM AND METHOD FOR COOLING A NOZZLE

(75) Inventor: Mahesh Bathina, Bangalore (IN)

(73) Assignee: GENERAL ELECTRIC COMPANY, Schenectady, NY (US)

(21) Appl. No.: 12/911,120

(22) Filed: Oct. 25, 2010

(51) Int. Cl. B05B 17/04; B64D 33/04

(52) U.S. Cl. 239/13; 239/127.1

(57) ABSTRACT

A nozzle includes a center body. A shroud circumferentially surrounds at least a portion of the center body to define an annular passage between the center body and the shroud. A closed loop cooling circuit extends inside the center body. A method for cooling a nozzle includes flowing a cooling medium through a closed loop cooling circuit inside the nozzle.

### FIELD OF THE INVENTION

The present invention generally involves a system and method for cooling a nozzle. In particular, embodiments of the present invention may provide a cooling medium through a closed loop cooling circuit to cool surfaces of the nozzle.

### BACKGROUND OF THE INVENTION

Gas turbines are widely used in industrial and power generation operations. A typical gas turbine includes an axial compressor at the front, one or more combustors around the middle, and a turbine at the rear. Ambient air enters the compressor, and rotating blades and stationary vanes in the compressor progressively impart kinetic energy to the air to produce a compressed working fluid at a highly energized state. The compressed working fluid exits the compressor and flows through nozzles in the combustors where it mixes with fuel and ignites to generate combustion gases having a high temperature and pressure. The combustion gases expand in the turbine to produce work. For example, expansion of the combustion gases in the turbine may rotate a shaft connected to a generator to produce electricity.

It is widely known that the thermodynamic efficiency of a gas turbine increases as the operating temperature, namely the combustion gas temperature, increases. However, if the fuel and air are not evenly mixed prior to combustion, localized hot spots may form in the combustor. The localized hot spots increase the chance for the flame in the combustor to flash back into the nozzles and/or become attached inside the nozzles which may damage the nozzles. Although flame flash back and flame holding may occur with any fuel, they occur more readily with high reactive fuels, such as hydrogen, that have a higher burning rate and a wider flammability range.

A variety of techniques exist to allow higher operating temperatures while minimizing flash back and flame holding. Many of these techniques seek to reduce localized hot spots and/or reduce low flow zones to prevent or reduce the occurrence of flash back or flame holding. For example, continuous improvements in nozzle designs result in more uniform mixing of the fuel and air prior to combustion to reduce or prevent localized hot spots from forming in the combustor. Alternately, or in addition, nozzles have been designed to ensure a minimum flow rate of fuel and/or air through the nozzle to cool the nozzle surfaces and/or prevent the combustor flame from flashing back into the nozzle. However, continued improvements in nozzle designs to reduce and/or prevent the occurrence of flame holding or flash back would be useful.

### BRIEF DESCRIPTION OF THE INVENTION

Aspects and advantages of the invention are set forth below in the following description, or may be obvious from the description, or may be learned through practice of the invention.

One embodiment of the present invention is a nozzle that includes a center body. A shroud circumferentially surrounds at least a portion of the center body to define an annular passage between the center body and the shroud. A closed loop cooling circuit extends inside the center body.

Another embodiment of the present invention is a nozzle that includes a center body. A shroud circumferentially surrounds at least a portion of the center body to define an annular passage between the center body and the shroud. A closed loop cooling circuit extends outside the nozzle along the shroud.

The present invention also includes a method for cooling a nozzle. The method includes flowing a cooling medium through a closed loop cooling circuit inside the nozzle.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a simplified side cross-section view of a combustor according to one embodiment of the present invention;

FIG. 2 is an axial cross-section view of the combustor shown in FIG. 1;

FIG. 3 is a simplified side cross-section of a nozzle according to one embodiment of the present invention;

FIG. 4 is a perspective view of a vane according to one embodiment of the present invention; and

FIG. 5 is a perspective view of a vane according to an alternate embodiment of the present invention.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

Various embodiments of the present invention provide cooling to nozzle surfaces to reduce the occurrence of flame holding and, if flame holding occurs, to reduce and/or prevent any damage to the nozzle surfaces. Particular embodiments may include a closed loop cooling circuit that circulates a cooling medium through and/or adjacent to nozzle components to cool the nozzle.

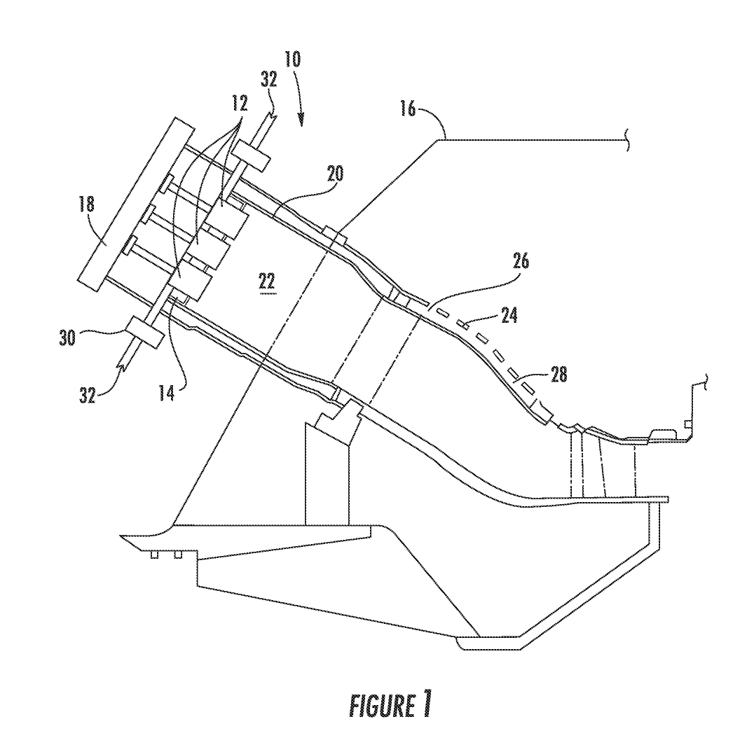

FIG. 1 shows a simplified cross-section of a combustor 10 according to one embodiment of the present invention. As shown, the combustor 10 generally includes one or more nozzles 12 radially arranged in a top cap 14. A casing 16 may surround the combustor 10 to contain the air or compressed working fluid exiting the compressor (not shown). An end cap 18 and a liner 20 may define a combustion chamber 22 downstream of the nozzles 12. A flow sleeve 24 with flow holes 26 may surround the liner 20 to define an annular passage 28 between the flow sleeve 24 and the liner 20.

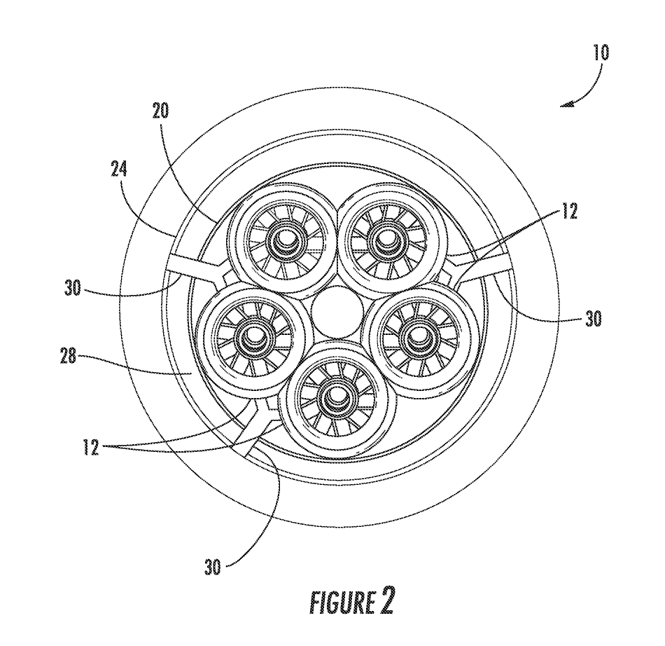

FIG. 2 provides a top plan view of the combustor 10 shown in FIG. 1. Various embodiments of the combustor 10 may include different numbers and arrangements of nozzles. For example, in the embodiment shown in FIG. 2, the combustor 10 includes five nozzles 12 radially arranged. The working fluid flows through the annular passage 28 between the flow sleeve 24 and the liner 20 until it reaches the end cap 18 where it reverses direction to flow through the nozzles 12 and into the combustion chamber 22.

As shown in FIGS. 1 and 2, a manifold 30 may connect to the nozzles 12 to supply a cooling medium 32 to and/or through the nozzles 12. The manifold 30 may include any pipe and valve arrangement known to one of ordinary skill in the art for providing fluid communication. The cooling medium 32 may comprise any fluid suitable for removing heat. For example, the cooling medium 32 may comprise steam, a refrigerant, an inert gas, a diluent, or another suitable fluid known to one of ordinary skill in the art. The cooling medium 32 may be supplied to the nozzles 12 continuously or only when desired to provide additional cooling to the nozzles 12.

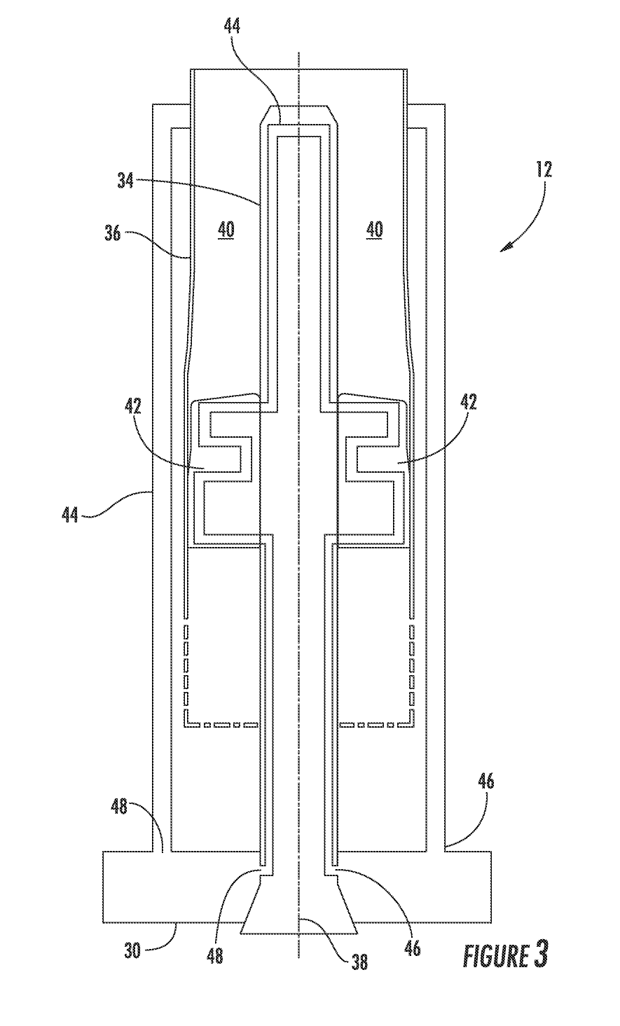

FIG. 3 shows a simplified side cross-section of the nozzle 12 according to one embodiment of the present invention. As shown in FIG. 3, the nozzle 12 generally includes a center body 34 and a shroud 36. The center body 34 generally extends along an axial centerline 38 of the nozzle 12. The shroud 36 circumferentially surrounds at least a portion of the center body 34 to define an annular passage 40 between the center body 34 and the shroud 36. The nozzle 12 may further include one or more vanes 42 in the annular passage 40 between the center body 34 and the shroud 36 that impart tangential velocity to fuel and/or the working fluid flowing over the vanes 42. In this manner, the working fluid may flow through the annular passage 40 and mix with fuel injected from the center body 34 and/or vanes 42 into the annular passage 40.

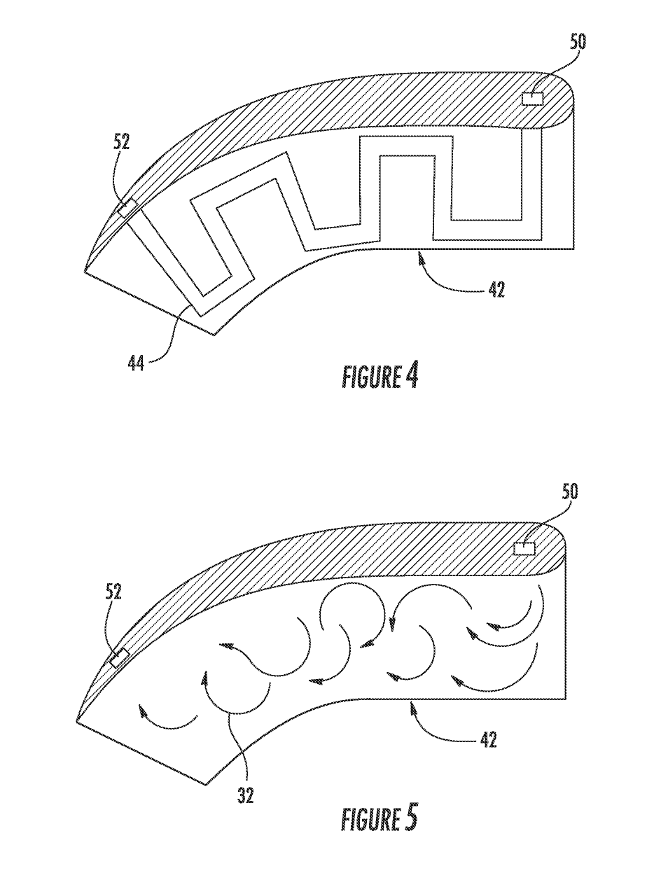

As shown in FIG. 3, the nozzle 12 may further include a closed loop cooling circuit 44 that provides fluid communication for the cooling medium 32 through and/or around the nozzle 12. As used herein, “closed loop” means that the cooling medium 32 is not intentionally released from the cooling circuit 44 to flow through the nozzle 12 and/or into the combustion chamber 22. As shown in FIG. 3, the closed loop cooling circuit 44 may extend into, around, and/or through one or more of the center body 34, vanes 42, and/or shroud 36. For example, the closed loop cooling circuit 44 may extend inside the center body 34 to remove heat from the center body 34 and thus cool the exterior surface of the center body 34. Similarly, the closed loop cooling circuit 44 may extend outside the nozzle 12 along the shroud 36 to cool the interior surface of the shroud 36. As shown in more detail in FIGS. 4 and 5, the closed loop cooling circuit 44 may further extend inside the vanes 42 to provide fluid communication for the cooling medium 32 through the vanes 42. For example, as shown in FIG. 4, the closed loop cooling circuit 44 may include a serpentine flow path through the vanes 42 to cool the exterior surfaces of the vanes 42. Alternately, as shown in FIG. 5, the closed loop cooling circuit 44 may include an inlet 50 and an outlet 52 to the vanes 42 to provide fluid communication for the cooling medium 32 through the vanes 42. In this manner, the cooling medium 32 flows through the closed loop cooling circuit 44 to remove heat from the center body 34, vanes 42, and/or shroud 36 to cool the respective surfaces of the nozzle 12.

One of ordinary skill in the art will readily appreciate that the closed loop cooling circuit 44 may comprise multiple supply 46 and return 48 connections at various locations to provide fluid communication for the cooling medium 32 to flow from the manifold 30, through the closed loop cooling circuit 44, and back to the manifold 30. For example, the closed loop cooling circuit 44 may comprise supply and return connections 46, 48 through the shroud 36. In this manner, the cooling medium 32 may flow from the manifold 30, through the shroud 36, and through the vanes 42 and/or center body 34, before returning back to the manifold 30 through the shroud 36. Alternately, or in addition, the closed loop cooling circuit 44 may comprise a supply connection 46 through the shroud 36 and a return connection 48 through the center body 34. In this manner, the cooling medium 32 may flow from the manifold 30, through the shroud 36, and through the vanes 42 and/or center body 34, before returning back to the manifold 30 through the center body 34. These and other flow paths for the closed loop cooling circuit 44 are within the scope of various embodiments of the present invention.

One of ordinary skill in the art will readily appreciate that the embodiments previously described and illustrated with respect to FIGS. 3, 4, and 5 provide a method for cooling a nozzle. For example, the method may include flowing the cooling medium 32 through the closed loop cooling circuit 44 inside the nozzle 12. In particular embodiments, the method may further include flowing the cooling medium 32 through the closed loop cooling circuit 44 inside the center body 34, inside the vanes 42, and/or outside the shroud 36 to remove heat from the nozzle 12.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other and examples are intended to be within the scope of the claims if they include structural elements that do not differ from the literal language of the claims, or if they include equivalent structural elements with insubstantial differences from the literal languages of the claims.

What is claimed is:

1. A nozzle comprising:
a. a center body;
b. a shroud circumferentially surrounding at least a portion of the center body to define an annular passage between the center body and the shroud; and
c. a closed loop cooling circuit extending inside the center body.

2. The nozzle as in claim 1, further comprising a cooling medium flowing through the closed loop cooling circuit.

3. The nozzle as in claim 2, wherein the cooling medium comprises at least one of steam, an inert gas, a refrigerant, or a diluent.

4. The nozzle as in claim 1, further comprising at least one vane between the center body and the shroud.

5. The nozzle as in claim 4, wherein the closed loop cooling circuit extends inside the at least one vane.

6. The nozzle as in claim 4, wherein the closed loop cooling circuit provides fluid communication for a cooling medium through the at least one vane.

7. The nozzle as in claim 1, wherein the closed loop cooling circuit extends outside the nozzle along the shroud.

8. The nozzle as in claim 1, wherein the closed loop cooling circuit comprises a supply and a return.

9. A nozzle comprising:
a. a center body;
b. a shroud circumferentially surrounding at least a portion of the center body to define an annular passage between the center body and the shroud; and
c. a closed loop cooling circuit extending outside the nozzle along the shroud.

10. The nozzle as in claim 9, further comprising a cooling medium flowing through the closed loop cooling circuit.

11. The nozzle as in claim 10, wherein the cooling medium comprises at least one of steam, an inert gas, a refrigerant, or a diluent.

12. The nozzle as in claim 9, further comprising at least one vane between the center body and the shroud.

13. The nozzle as in claim 12, wherein the closed loop cooling circuit extends inside the at least one vane.

14. The nozzle as in claim 12, wherein the closed loop cooling circuit provides fluid communication for a cooling medium through the at least one vane.

15. The nozzle as in claim 9, wherein the closed loop cooling circuit extends inside the center body.

16. The nozzle as in claim 9, wherein the closed loop cooling circuit comprises an inlet and an outlet.

17. A method for cooling a nozzle comprising:
a. flowing a cooling medium through a closed loop cooling circuit inside the nozzle.

18. The method as in claim 17, further comprising flowing the cooling medium through the closed loop cooling circuit inside a center body in the nozzle.

19. The method as in claim 17, further comprising flowing the cooling medium through the closed loop cooling circuit outside a shroud surrounding the nozzle.

20. The method as in claim 17, further comprising flowing the cooling medium through the closed loop cooling circuit inside a vane extending between a shroud and a center body.
